(19) United States
(12) Patent Application Publication
(10) Pub. No.: US 2013/0292967 A1
(43) Pub. Date: Nov. 7, 2013

(54) DRAG REDUCING DECORATIVE TAILGATE

(71) Applicant: Ronald Schmitz, Sauk Centre, MN (US)

(72) Inventor: Ronald Schmitz, Sauk Centre, MN (US)

(21) Appl. No.: 13/888,088

(22) Filed: May 6, 2013

Related U.S. Application Data
(60) Provisional application No. 61/643,706, filed on May 7, 2012.

(51) Int. Cl. B62D 35/00; B62D 33/027

(52) U.S. Cl. CPC B62D 35/00; B62D 33/0273
USPC 296/180.1; 296/57.1

(57) ABSTRACT

A drag reducing tailgate with decorative attachments. The tailgate may include a frame with an upper board, a lower board, a first side board, and a second side board. An opening may be formed in between the boards. A decorative attachment, such as an antler, may be attached to the lower board and extend passed the opening and up to the upper board.

### BACKGROUND OF THE INVENTION

The present invention relates to a decorative tailgate and, more particularly, to a decorative tailgate that provides less wind resistance.

A tailgate may include a door or access ‘gate’ at the back of a station wagon, pickup truck, sport utility vehicle (SUV) or other similar type of vehicle that is hinged at the bottom and can be opened for the convenience of loading cargo into the rear of the vehicle. Tailgate's on pickup trucks currently have too much wind resistance and are plain looking. Given the wind resistance of the tailgates, the pickup truck's gas mileage may be affected.

As can be seen, there is a need for a tailgate that can be customized and provide less wind resistance.

### SUMMARY OF THE INVENTION

In one aspect of the present invention, a tailgate of a pickup truck comprises: a frame comprising an upper board, a lower board, a first side board, and a second side board, wherein an opening is formed therebetween; a hinge connecting the lower board of the frame to the pickup truck; a latch system releasably connecting the upper board to the pickup truck; and at least one decorative piece extending from the lower board to the upper board.

These and other features, aspects and advantages of the present invention will become better understood with reference to the following drawings, description and claims.

### BRIEF DESCRIPTION OF THE DRAWINGS

FIG. 1 is a perspective view of the present invention shown in use and in a closed configuration;

FIG. 2 is a perspective view of the present invention shown in use and in an open configuration;

FIG. 3 is a side view of the present invention;

FIG. 4 is a perspective view of the present invention;

FIG. 5 is a rear perspective view of the present invention;

FIG. 6 is a rear detail perspective view of the present invention;

FIG. 7 is a rear view of the present invention shown with latch bolt of FIG. 2 in an extended configuration;

FIG. 8 is a rear view of the present invention shown with latch bolt of FIG. 2 in a retracted configuration;

FIG. 9 is section detail view of the present invention along line 9-9 in FIG. 6 shown in latch extended configuration; and

FIG. 10 is section detail view of the present invention shown in latch extended configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a drag reducing tailgate with decorative attachments. The tailgate may include a frame with an upper board, a lower board, a first side board, and a second side board. An opening may be formed in between the boards. A decorative attachment, such as an antler, may be attached to the lower board and extend passed the opening and up to the upper board.

The present invention may include a customized tailgate that prevents items from falling out of the bed of the pickup truck. The present invention may further reflect the owner's personality of enjoying hunting and the outdoors. Further, the present invention gives the pickup truck a custom look while reducing drag.

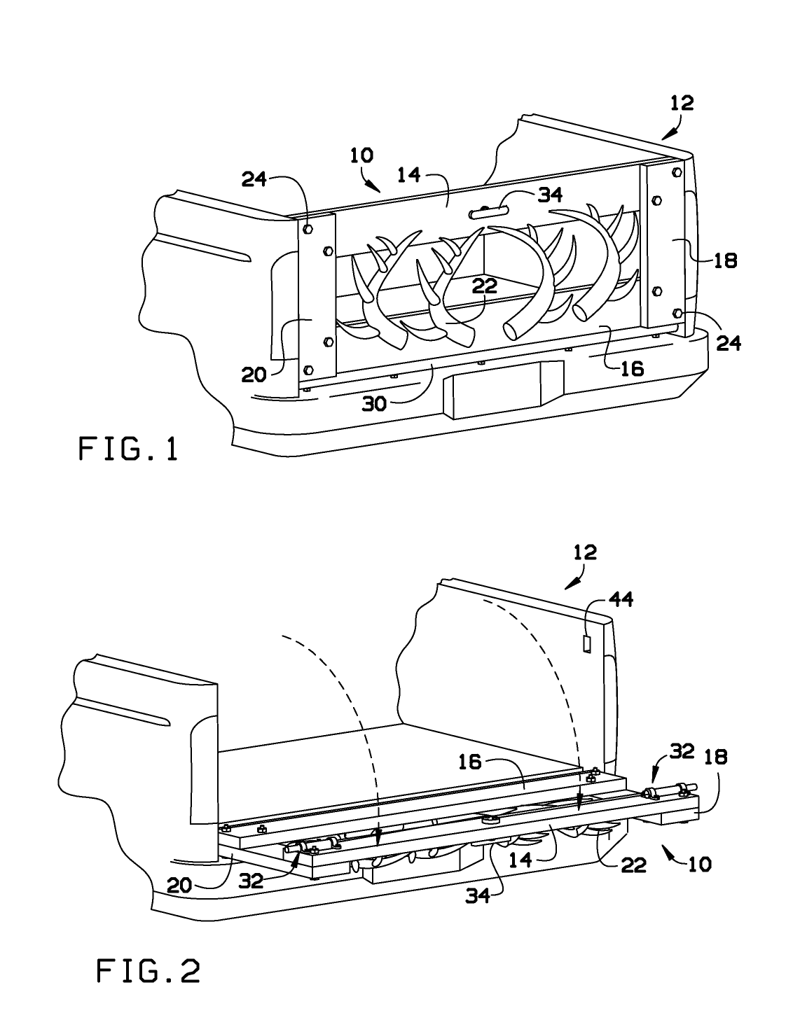

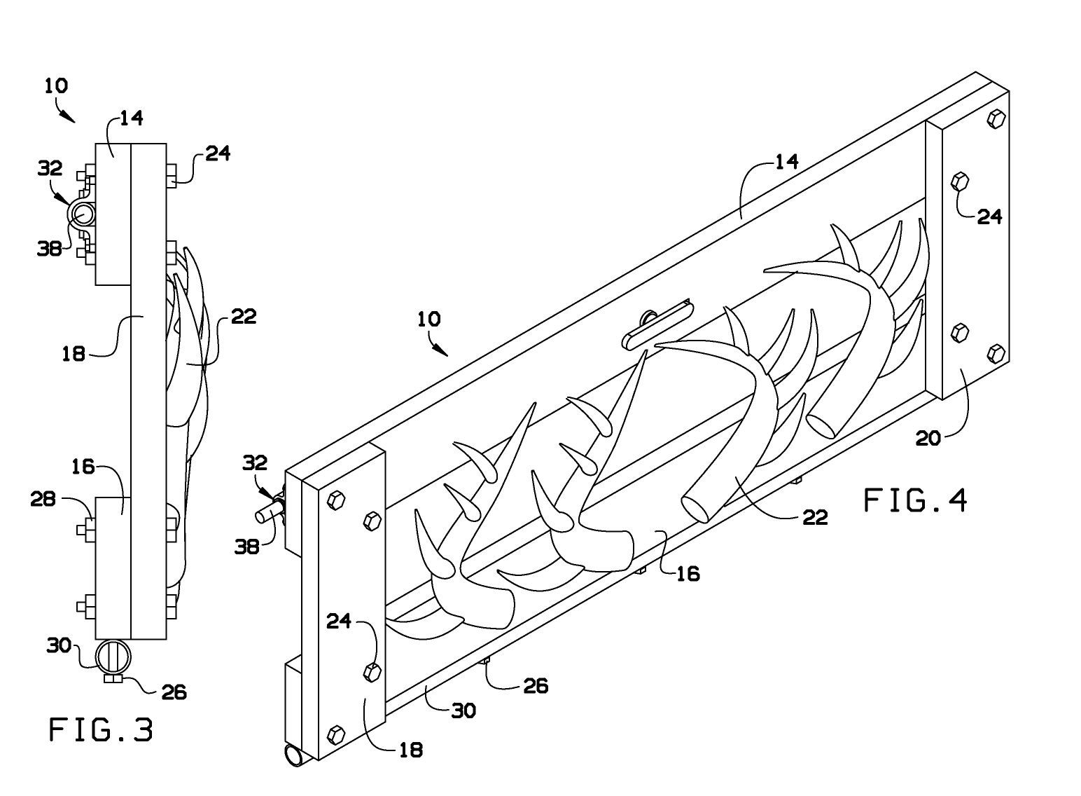

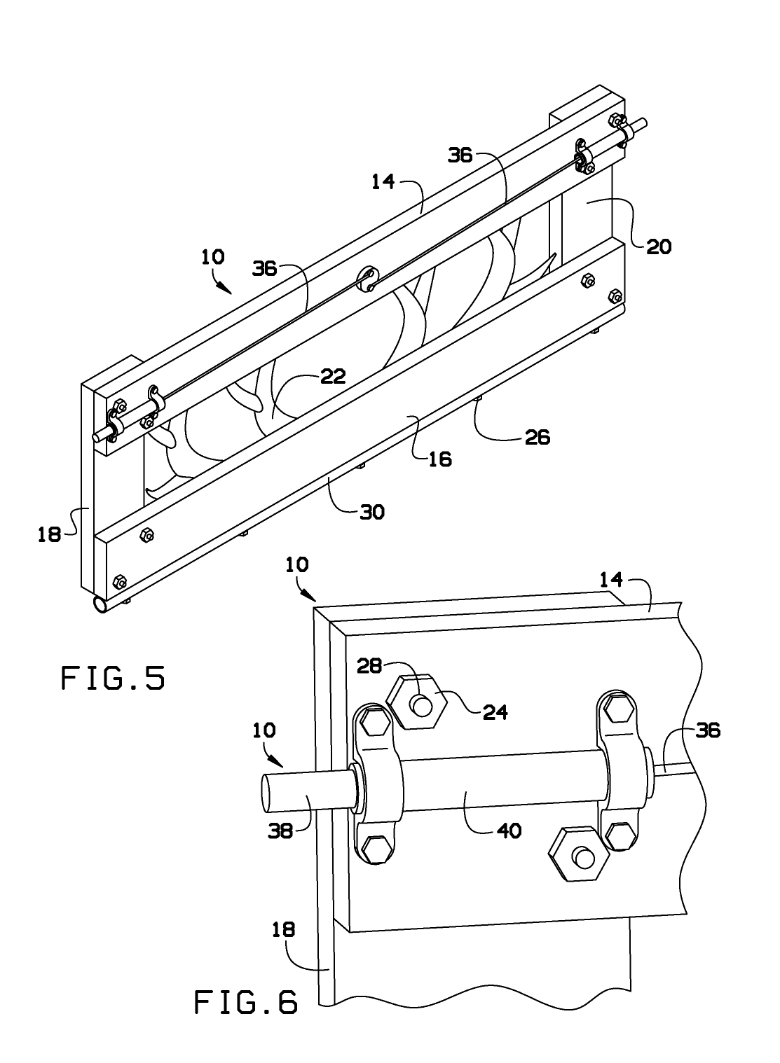

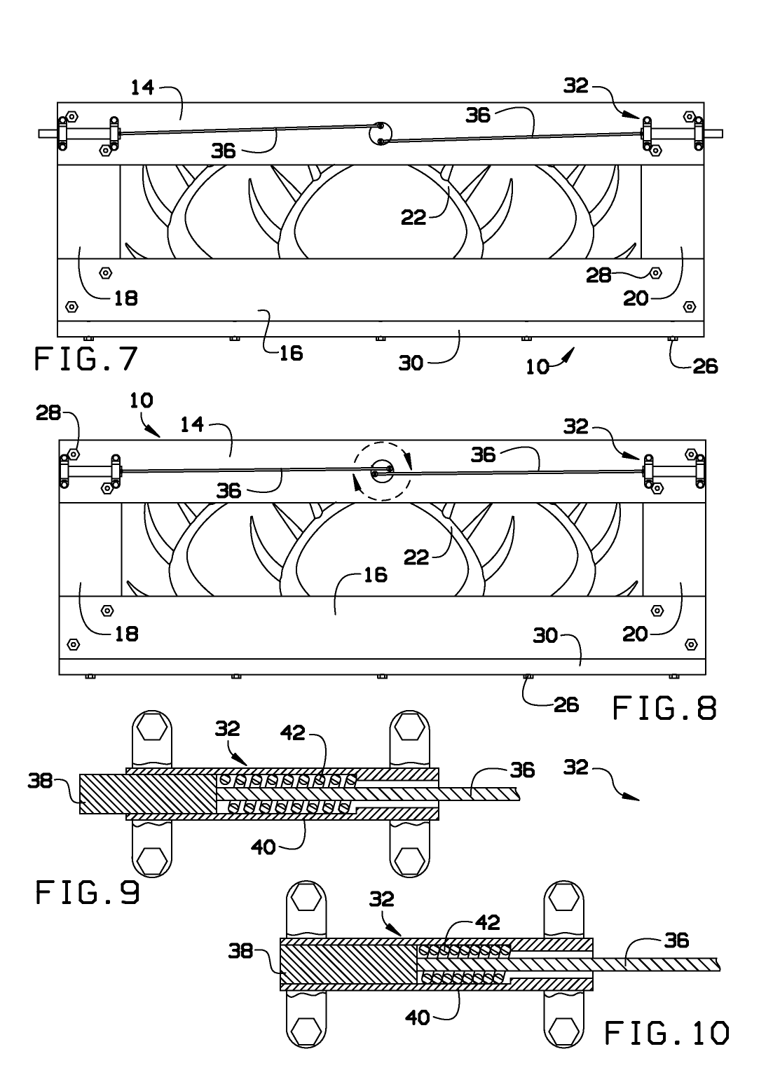

Referring to FIGS. 1 through 9, the present invention may include a tailgate 10 attached to a pickup truck 12. The tailgate 12 may include a frame. The frame may include an upper board 14, a lower board 16, a first side board 18, and a second side board 20. Formed in between the upper board 14, the lower board 16, the first side board 18, and the second side board 20 is an opening. At least one decorative piece 22, such as an antler or horn may be attached to the frame. In certain embodiments, the decorative piece 22 may be attached to the lower board 16 and extend across the opening. In certain embodiments, the at least one decorative piece 22 may include four antlers 22 attached to the lower board 16 and extending over the opening and up to the upper board 14.

In certain embodiments, the upper board 14, the first side board 18, the lower board 16 and the second side board 20 may be mounted together using bolts 24. Nuts 28 may be secured to the bolts 24 to further secure the frame together. A bottom pipe 30 may be mounted to the bottom of the lower board 16 with lag bolts 26. The bottom pipe 30 may be hinged to the truck bed. Therefore, as illustrated in FIG. 2, the tailgate 10 may swing up and down relative to the truck bed.

The tailgate 10 of the present invention may further include a latch 32 to secure the tailgate 10 in a closed position. The latch 32 may include a cable 36 attached to a latch bolt 38. A latch pipe casing 40 may be attached at either end of the upper board. The latch pipe casing 40 may house the latch bolt 38. A spring 42 may be within the latch pipe casing 40 and may keep the latch bolt extended out of the latch pipe casing 40 in a rested position. A tailgate latch port 44 on the truck bed may receive the latch bolt 38. Therefore, in a closed position, the tailgate 10 is upright and the latch bolt 38 is within the tailgate latch port 44, thereby securing the tailgate 10 in the upright position. To open the tailgate 10, a handle 34 may be operatively connected to the cables 36 that are attached to the latch bolts 38. When the handle 34 is turned the latch bolts 38 may be pulled inward and released from the tailgate latch ports 44. This allows the tailgate 10 to swing down in the open configuration.

It should be understood, of course, that the foregoing relates to exemplary embodiments of the invention and that modifications may be made without departing from the spirit and scope of the invention as set forth in the following claims.

What is claimed is:

1. A tailgate of a pickup truck comprising:
a frame comprising an upper board, a lower board, a first side board, and a second side board, wherein an opening is formed therebetween;
a hinge connecting the lower board of the frame to the pickup truck;
a latch system releasably connecting the upper board to the pickup truck; and
at least one decorative piece extending from the lower board to the upper board.

2. The tailgate of claim 1, wherein the at least one decorative piece comprises at least of a horn and an antler.

3. The tailgate of claim 1, wherein the at least one decorative piece comprises four antlers.

4. The tailgate of claim 1, wherein the upper board, the lower board, the first side, and the second side board are attached to one another via a plurality of bolts and a plurality of nuts.

5. The tailgate of claim 1, further comprising a pipe secured to the bottom of the lower board.

6. The tailgate of claim 1, wherein the latch system comprises:
a handle mounted to an outside surface of the upper board;
a retractable latch bolt operatively connected to the handle by a wire;
a latch pipe casing attached to an inside surface of the upper board housing the retractable latch bolt; and
a spring, wherein the spring suspends the latch bolt at least partially outside of the latch pipe casing, wherein turning the handle pulls the retractable latch into the latch pipe casing.
